(19) United States
(12) Patent Application Publication
(10) Pub. No.: US 2009/0172082 A1
(43) Pub. Date: Jul. 2, 2009

(54) SOFTWARE AS A SERVICE IN A PEER-TO-PEER ENVIRONMENT

(76) Inventor: Joaquin Sufuentes, Portland, OR (US)

Correspondence Address: INTEL CORPORATION;c/o CPA Global, P.O. BOX 52050, MINNEAPOLIS, MN, 55402, US

(21) Appl. No.: 11/967,707

(22) Filed: Dec. 31, 2007

(51) Int. Cl. G06F 15/16; G06F 21/00

(52) U.S. Cl. 709/203; 726/3

(57) ABSTRACT

A method and system are disclosed. In one embodiment the method includes populating a software as a service (SaaS) application lookup table on a first computer system on a network with a first categorized set of pointers. Each pointer includes one or more storage locations within one or more peer computer systems on the network where at least a portion of a first SaaS application resides. The method also includes the first computer system requesting access to one or more portions of the first SaaS application from at least one of the one or more peer computer systems. The method also includes the first computer system receiving one or more streams of the one or more portions of the first SaaS application from the at least one of the one or more peer computer systems on the network, when access is granted.

### FIELD OF THE INVENTION

The invention relates to enabling software as a service in a peer-to-peer environment.

### BACKGROUND OF THE INVENTION

Software as a service (SaaS) is a software application delivery model where, (1) a software vendor develops a web-native software application and hosts and operates (either independently or through a third-party) the application for use by its customers over the Internet, or (2) a client specific application (such as a word processing or spreadsheet program) is “streamed” or packaged into chunks or applets that are downloaded to the client, when needed as needed. The advantage of these SaaS models is that customers do not pay for owning the software itself but rather for using it.

Peer-to-peer (P2P) file sharing communications protocols such as Napster, Pando, BitTorrent or ChunkySpread have become increasingly popular as more video, audio, and other types of files are shared among an active World Wide Web community. With P2P file sharing, large amounts of data can be widely distributed without the original distributor incurring the entire costs of the distribution (these costs may include hardware costs, hosting costs, and bandwidth resources, among other costs). Instead, in the latest embodiments of P2P, more aptly labeled “peer-assisted”, data is distributed using a file sharing protocol in which each recipient supplies pieces of the data to newer recipients, reducing the cost and burden on any given individual source. Apart from reducing dependence on a single distributor or distribution system, this also provides redundancy for high availability, and a value in avoiding bandwidth bottlenecks for large content files.

### BRIEF DESCRIPTION OF THE DRAWINGS

The present invention is illustrated by way of example and is not limited by the drawings, in which like references indicate similar elements, and in which:

FIG. 1 describes one embodiment of a peer-to-peer software as a service (SaaS) network.

FIG. 2 is a flow diagram of one embodiment of a process to stream portions of a SaaS application from one or more peer computer systems.

### DETAILED DESCRIPTION OF THE INVENTION

Embodiments of a method and system to enable software as a service in a peer-to-peer environment are described. In the following description, numerous specific details are set forth. However, it is understood that embodiments may be practiced without these specific details. In other instances, well-known elements, specifications, and protocols have not been discussed in detail in order to avoid obscuring the present invention.

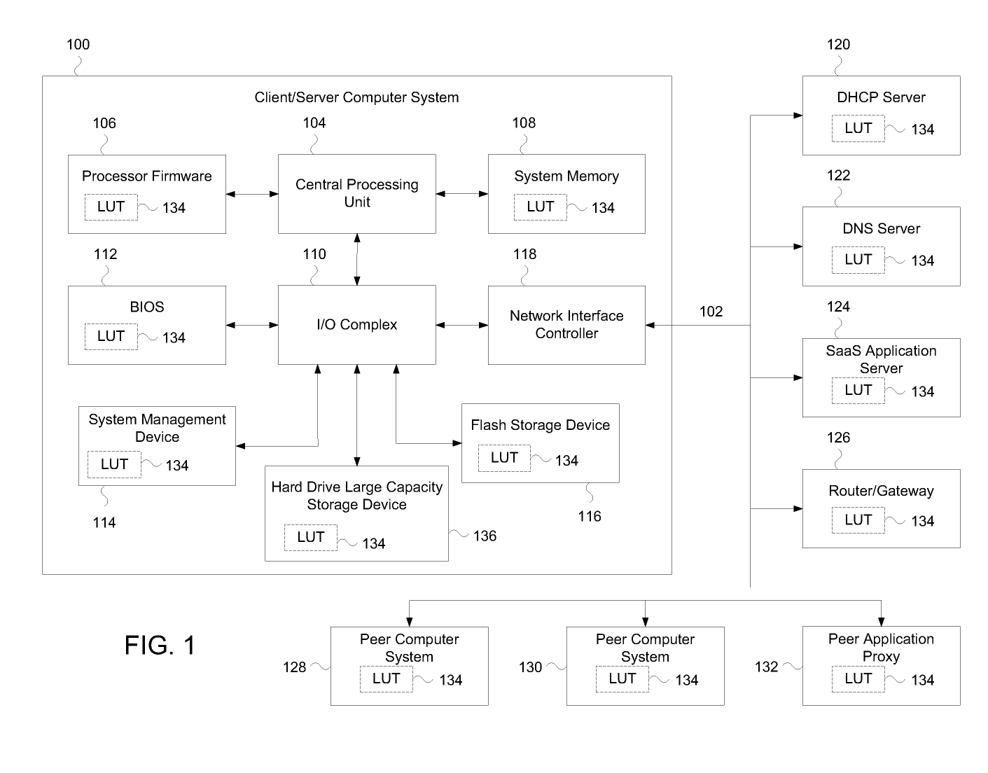

FIG. 1 describes one embodiment of a peer-to-peer software as a service (SaaS) network. In many embodiments, a first client or server machine (i.e. computer system) 100 resides on network 102 that includes multiple additional computer systems. The network 102 may be any type of network in different embodiments. For example, network 102 may be an enterprise network (e.g. an intranet) within a company or organization, a personal home network, a rack of servers within a datacenter, the Internet, or any other viable network. The network may be a wired network (e.g. utilizing Ethernet cables) or a wireless network (e.g. utilizing IEEE 802.11-type wireless protocols), or a combination of both (where portions of the network are wired and portions are wireless).

The first client/server computer system 100 includes a number of standard components within a computer system. In many embodiments, the first client/server computer system 100 includes one or more processors, such as central processing unit (CPU) 104. In different embodiments, CPU 104 may include one core or multiple cores. In some embodiments, the system is a multiprocessor system (not shown) where each of the processors has one core or multiple cores.

CPU 104 is coupled to processor firmware 106 in many embodiments. Although in FIG. 1, processor firmware 106 is shown as a discrete component separate from CPU 104, in some embodiments, processor firmware 106 is located on the CPU 104 chip. Processor firmware 106 may store processor microcode updates, authenticated code modules, a firmware interface table, legacy boot code, as well as a number of other pieces of information.

In many embodiments, CPU 104 is also coupled to system memory 108 through one or more high speed links (i.e. interconnects, buses, etc). System memory 108 is capable of storing information that CPU 104 utilizes to operate and execute programs and operating systems running on the first client/server computer system 100. In different embodiments, system memory 108 may be any usable type of readable and writeable memory such as a form of dynamic random access memory (DRAM).

Furthermore, CPU 104 is also coupled to I/O complex 110 in many embodiments. I/O complex 110 may house one or more I/O host controllers (not shown), each of which control one or more I/O links that allow CPU 104 to communicate with I/O devices and peripherals coupled to the first client/server computer system 100. I/O peripherals such as a display, a printer, a keyboard, and other such external peripherals may be coupled to I/O complex 110. Other devices may also be attached to I/O complex 110 that are not external to the first client/server computer system 100, such as BIOS (basic input/output system) 112.

BIOS 112 is stored in a platform firmware device in many embodiments. BIOS 112 contains pre-operating system boot instructions to initialize many components within the first client/server computer system 100.

Another such device that is coupled to I/O complex 110 in many embodiments is a system management device 114. For example, an Intel® Active Management Technology device (one type of system management device) may be coupled to I/O complex 110. An additional device that is coupled to I/O complex 110 in many embodiments is a flash storage device 116. The flash storage device 116 may store a backup operating system, one or more large buffers that store information from an attached storage device such as a hard drive with high capacity storage 136, among other items.

Finally, a network interface controller (NIC) 118 is coupled to the I/O complex in many embodiments. In many embodiments, the NIC 118 controls the first client/server computer system 100 access to the network 102. In some embodiments, the NIC 118 may have an Ethernet cable attached to it that couples the NIC 118 to a wired network. In other embodiments, the NIC 118 may have an antenna attached to it that allows the NIC to connect to a wireless network.

In many embodiments, one or more servers reside on network 102. These servers may include a dynamic host control protocol (DHCP) server 120, a domain name system (DNS) server 122, and a SaaS application server 124. Servers such as these are typically found in larger networks. As the networks get even larger, multiple DHCP, DNS, and even SaaS application servers may be located on the network (multiple servers of a single type are not shown in FIG. 1).

In smaller networks, such as a personal home network, a router 126 (i.e. gateway) may be located on the network.

In many embodiments, one or more peer computer systems to the first computer system are also located on network 102. These can be additional client systems, such as portable devices, laptops, handhelds, personal computers, gaming consoles, set-top boxes such as Intel® ViiV™ or TiVo® or server systems, depending on the location and consistency of the network. For example, peer computer systems 128 and 130 (as well as peer application proxy 132) are shown in FIG. 1. In many large networks there may be hundreds or thousands of peer computer systems in the network, scaling to millions when taking the vastness of the Internet into account.

SaaS software applications and SaaS operating systems (these items are referred to simply as “SaaS applications” below for simplicity) are normally distributed or streamed to paying client systems solely from a centralized server or from a series of servers in a datacenter across a network. In the peer-to-peer SaaS network as described in FIG. 1, SaaS applications are each accessed from one or more peer computer systems.

A SaaS application look up table (LUT) 134 resides on one or more computer systems in the network. The SaaS application LUT 134 is populated with one or more pointers to neighboring client devices that may be accessed for delivery of software blocks. A “block” refers to a file that contains at least a portion of the SaaS application within a peer computer system. The pointers may be categorized in a number of different ways in the SaaS application LUT 134, such as being categorized by application, by provider of the application, by type of license, or other logical grouping that allows one LUT to hold credentials, pointers, and other enabling information from multiple application providers. A peer computer that requests access to a SaaS application uses one or more pointers stored in a SaaS application LUT 134 (stored on the peer computer requesting the access) to find these portions of the application. Depending on the size of the application and the way the application is structured, the application may be shared between computers in multiple distinct portions, where the combination of all of the portions is required to rebuild an instantiation of the application successfully at the requesting computer. In other embodiments, the application is sent as a whole.

Furthermore, to guard against intruders in the network attempting to receive an instantiation of an application from one or more of the peer computers, a security key system of encryption may be utilized in many embodiments. For example, in some embodiments, a first peer computer currently has (i.e. stores) at least a portion of a SaaS application requested by a second peer computer. The first peer computer may only stream the portion(s) of the SaaS application to the second peer computer if the second peer computer provides the first peer computer a security key that authorizes the second peer computer to receive the portion(s). In other embodiments, the portions of an SaaS application may be encrypted when sent between peer computers on the network and only those computers with security key may be able to decrypt the portion(s) received. This model may be utilized with the “network coding” transport method, which is a method of attaining maximum information flow across a network.

The security keys (and algorithms that are needed to utilize the security keys) on peer computer systems can be kept in synch (and rotated as necessary) by having the SaaS application server 124 distribute regular updates throughout the network of peers, or by having other entities populating the LUT, such as DHCP server 120 or DNS server 122 cascade new security keys regularly. Additionally, security keys may be generated by each client by utilizing a software based number generator that is synched initially from one source at initial deployment.

In an enterprise network environment, using the existing network authentication and authorization services to populate the LUT allows for a reduced performance impact to the peer computer systems regarding examining lengthy keys, populating and repopulating the LUT, as well as provide processing for compute intensive algorithms. However, since the authentication of credentials is handled by the network, enterprise network authentication would be mainly utilized in an enterprise environment where access and authentication are standardized per a given set of peered computer systems. In many embodiments, a SaaS proxy (discussed below) is capable of checking the security key integrity on all peered clients in the network.

In the typical deployment of a SaaS environment in the enterprise today, a SaaS application server in the network, such as SaaS application server 124 maintains the master copy of the SaaS application LUT 134 for licensing purposes. Alternatively, in the current embodiments discussed, a SaaS application server “proxy” 132 will be designated among the peers in a network community, such as exists in an enterprise local area network (LAN) or in a service providers metropolitan area network (MAN). This SaaS proxy 132 generally acts as the originating server of all of the SaaS applications and can maintain a list of applications that are available in the SaaS environment. The SaaS proxy 132 also maintains the list of available licenses to be used among a community of peer computers in the network as well as the security protocol to be enforced for sharing and distributing the applications. When the network 102 has relatively few peer computer systems actively connected, the SaaS application proxy 132 may itself distribute copies of the SaaS application LUT 134 to any new peer computer system entering the network, as well as the SaaS applications themselves. “Actively” connected to the network may refer to the computer operating and able to transact with one or more other computers across the network in question. In many embodiments, the SaaS application proxy 132 also stores master copies of all of the applications themselves (including all portions), thus the SaaS application LUT 134 that the SaaS application proxy 132 hands out may have one or more blocks that point back to storage locations within the SaaS application proxy 132, rather than having all blocks within the SaaS application LUT 134 pointing to other peer computer systems on the network.

The SaaS application proxy 132, like the SaaS application server 124 which it replaces, in many embodiments, will keep an active count of peer computer systems actively connected to the network. Furthermore, the SaaS application proxy 132 may track usage of each application it stores. I.e. the SaaS application proxy 132 may keep an active count of the number of peer computer systems connected to the network that are currently utilizing an instantiation of each of the SaaS applications. For example, 26 instantiations of word processor program, 38 instantiations of email program, 11 instantiations of spreadsheet program, etc.

In many embodiments, the SaaS application proxy 132 is capable of logging all license requests to each SaaS application on the network. In many embodiments, the SaaS proxy 132 may convey all license requests to a service provider or an administrating authority for each of the applications. The SaaS proxy 132 may also be capable of denying access to any applications by any peered device when all the licenses have been exhausted.

If the SaaS proxy 132 is not capable of providing one or more of the services it normally performs, in many embodiments, the SaaS proxy has one or more failsafe mechanisms to push all of its services to other proxies distributed in the network hierarchy.

In many embodiments, the SaaS application proxy 132 may set a threshold number for active peer computer systems on the network and/or a threshold number of instantiations for each SaaS application. This threshold number, potentially determined by a network administrator or service provider for the application, would be utilized in the following way. In the example that a threshold number of active peer computer systems are connected to the network, once the threshold number has been reached, the SaaS application proxy 132 will offload a significant portion of its SaaS work to one or more proxies and/or one or more peer computer systems. Thus, in many embodiments, the SaaS application proxy 132 may push a copy of the SaaS application LUT 134 to one or more additional proxies on the network 102. For example, the SaaS application LUT 134 may be pushed to the DHCP server 120 or the pushed to the DNS server 122. In these embodiments, after the SaaS application LUT 134 has been pushed, the DHCP server 120 or the DNS server 122 may feed the SaaS application LUT 134 to all future new peer computer systems entering the network. In many embodiments, at any given time, each peer computer system on the network 102 will have a copy of the SaaS application LUT 134 resident in their memory.

This hands off a significant workload of the SaaS application server 124 to one or more of these other proxies or peer computer systems on the network reducing the need for capital investment in server infrastructure on the part of enterprises as well as operational costs to maintain the server infrastructure. Furthermore, this creates an efficient framework for utilizing the SaaS application LUT 134 since the DHCP and/or DNS servers (120 and 122 respectively) are two of the initial servers that each peer computer system interacts with upon entering the network 102. Thus, peer computer systems, such as 100, 128, 130, and 132, will have access to the SaaS application LUT 134 (and by implication, access to the applications themselves) faster upon entering the network 102. The value of the LUT 134 being populated at boot-up and network connection means that a client can also be given or fed its OS and applications from the network, through its peer community and lessen the need for costly updating to applications and OSes when security patches or feature enhancements change application images and are pushed to clients. The current embodiment includes a simplified network pull of applications versus the legacy push for software upgrades and updates.

In many embodiments, prior to the SaaS application proxy 132 pushing the SaaS application LUT 134 to the one or more additional servers, the SaaS application proxy 132 will perform periodic updates to each copy of the SaaS application LUT 134 on each of the peer computer systems on the network 102. Then, once the SaaS application proxy 132 has pushed the SaaS application LUT 134 to the one or more additional proxies, the SaaS application proxy 132 may only be required to perform the periodic updates to the one or more additional proxies that have been pushed the SaaS application LUT 134. At that point, the one or more additional proxies can then perform the periodic updates on each of the peer computer systems on the network themselves.

In other embodiments, instead of utilizing the threshold number to track a total number of active peer computer systems on the network, the threshold number may be instead utilized to track an active number of instantiations of any given application. For example, all instantiations of all SaaS applications on the network are tracked and if at least 5 instantiations of each potential application are currently running, then the push off may transpire. There are many other potential threshold number variations. Network administration may have the most efficient method of setting what the threshold number must be to allow the SaaS application proxy 132 to push the SaaS application LUT 134 to one or more additional proxies.

Furthermore, apart from a threshold number being required for the SaaS application proxy 132 to push the SaaS application LUT 134, there may be additional threshold numbers associated with whether portions (or all) of any given SaaS application will be streamed to a requesting peer computer system from the SaaS application proxy 132 or other peers in the community. One goal of a peer-to-peer distribution system is to offload a significant portion of the workload on a peer that otherwise would perform the task(s). In the case of streaming portions of the applications themselves, the SaaS application proxy 132 may allow one or more (including all) portions of an application to be streamed from itself to a requesting peer computer system if a threshold number of active peer computer systems (potentially ones that currently have an instantiation of the requested application) are not connected to the network 102. Once the threshold number of computer systems with an instantiation (or even a portion of an instantiation) of the requested application are actively connected to the network, the SaaS application proxy 132 may offload all application stream requests to those one or more peer computer systems with the portion(s) of the requested application.

In the embodiments described above, the SaaS application LUT 134 is standardized across the entire network 102 (i.e. a standard IT (information technology) bundle of SaaS applications).

In other embodiments, the SaaS application LUT 134 may be populated with pointers by an application service provider as a user selects applications to “purchase” in a SaaS framework, perhaps over the web. In these embodiments, the SaaS LUT is initially empty instead of populated with a standard build of SaaS application pointers. In these embodiments, the user will initially make an inquiry as to what programs are available from a web service offered by a service provider with either a SaaS application server 124, or a network of peers and proxies that stores a populated SaaS application LUT 134 and the SaaS application blocks themselves. It is assumed that the SaaS application server 124 will have a full selection of the SaaS applications since as the infrastructure of the service provider, it is the owner of the SaaS applications and of the master copy of the SaaS application LUT 124. It would also be beneficial, in these embodiments, that the one or more other proxies have a pushed copy of a complete SaaS application LUT 134 for a given region, geography, network or community, thus the end user's peer computer system inquiring as to the offered SaaS applications would receive a network optimized list from any server or proxy it inquires with.

In yet other embodiments, the peer computer system may include additional LUT logic that learns the characteristics of how a user utilizes the applications and operating systems on the computer system and then suggests a SaaS model that is more economically attractive. If the user is agreeable, the additional LUT logic, through one or more interactions with the SaaS application server 124 or one or more additional proxies on the network 102 will subsequently automatically populate the SaaS application LUT 134.

In non-enterprise environments, a part or all of the jobs described above that are performed by the SaaS application server 124 and/or the one or more additional servers (such as the DHCP server 120 and/or the DNS server 122) may be handed over to a router 126, gateway device, proxy or a peer computer system.

For any given peer computer system, such as the first peer computer system 100, the SaaS application LUT 134 is called into memory upon initial boot of the machine. The LUT can be a portion of the booting sequence of the computer system and serve to call up the operating system and applications the user want to see at initiation. The operating system and applications can be streamed to the computer during boot. In different embodiments, the stored LUT 134 may reside (i.e. be stored) in a trusted platform module (TPM) in processor firmware 106, in the BIOS 112, in a system management device 114, in a flash storage device 116, hard drive 136 or elsewhere. In some embodiments, the stored LUT may be loaded into system memory 108 to assist in location of the portions of the applications/operating systems to be received as streams during boot.

In many embodiments, a small application or applet, can be sent or conveyed (i.e. temporarily sent/lent) to a non-peered computer system to allow the non-peered computer system access to one or more SaaS applications. The small application or applet may give the non-peered computer system open access to an SaaS application for a duration of time. The duration may be determined by the network administrator or another administration agent in the network.

In other embodiments, the actual conveyance of the SaaS application may be limited to peers within the network from which the applet has emanated. In other embodiments, the actual conveyance of the SaaS application may be limited to the actual peer from which the applet has emanated.

In many embodiments, the applet may restrict the usage of the application in certain instances. For example, the applet may apply the above peer and non-peer rules itself. In another example, the applet may allow a computer system that has been conveyed the SaaS application to only use the application, when the system where the applet has originated (i.e. the inviting system) is not using the application. Additionally, when the applet is sent or conveyed to a non-peered system, the applet can extend a temporary license to use the SaaS application from a service provider.

In many embodiments, a peer on a network can invite another peer to gain access to one or more SaaS applications. This invitation can come in the form of the applet. Once a newly invited peer has the invitation/applet (sent to it from the other peer on the network), the SaaS proxy 132 is capable of providing temporary access to the SaaS applications. Additionally, the SaaS proxy 132 may also allow an invited peer to connect to the peer initiating the invite and use an SaaS application conveyed to the invited peer when the application is not in use by the peer that sent the invitation.

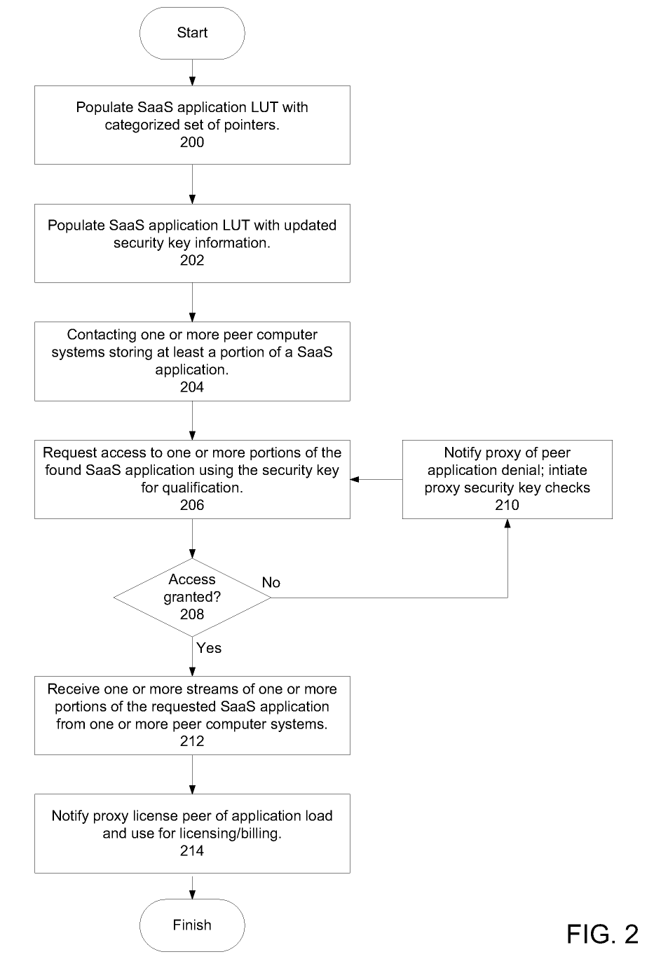

FIG. 2 is a flow diagram of one embodiment of a process to stream portions of a SaaS application from one or more peer computer systems. The process may be performed by hardware, software, or a combination of both. Turning to FIG. 2, the process begins by processing logic populating a SaaS application LUT with a categorized set of pointers (processing block 200).

Next, processing logic populates SaaS application LUT with a security key (processing block 202). In many embodiments, the security key is designed to qualify the peer computer system storing the populated LUT to gain access to one or more SaaS applications on one or more peer computer systems.

Then, processing logic uses the pointers within the SaaS application LUT to find one or more peer computer systems on a network that have stored portions of the SaaS application (processing block 204).

Once processing logic has found the one or more peer computer systems, processing logic then requests access to the one or more portions of the found SaaS application using the security key for qualification (i.e. authorization) (processing block 206).

Processing logic then checks if access is granted (processing block 208). If access is not granted, then the requesting peer contacts the proxy to run a check of the security key integrity in order to avoid future misconnections and loss of overall system performance (processing block 210). Otherwise, if access is granted, then processing logic receives one or more streams of the one or more portions of the requested application from the one or more peer computer systems (processing block 212).

Processing logic then reports to the proxy the availability of the SaaS application on the peer for other neighboring peers to draw from and the usage information which will serve to track licenses used and billing information, and then the process is finished.

Thus, embodiments of a method and system to enable software as a service in a peer-to-peer environment are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
populating a software as a service (SaaS) application lookup table on a first computer system on a network with a first categorized set of pointers, wherein each pointer includes one or more storage locations within one or more peer computer systems on the network where at least a portion of a first SaaS application resides;
the first computer system requesting access to one or more portions of the first SaaS application from at least one of the one or more peer computer systems; and
when access is granted, the first computer system receiving one or more streams of the one or more portions of the first SaaS application from the at least one of the one or more peer computer systems on the network.

2. The method of claim 1, further comprising:
populating the SaaS application lookup table on the first computer system with a security key, wherein the security key qualifies the first computer system to receive one or more streams of the one or more portions of the first SaaS application from at least one of the one or more peer computer systems on the network.

3. The method of claim 1, further comprising:
maintaining the SaaS application lookup table with the first categorized set of pointers initially on a SaaS application server on the network, wherein the SaaS server stores all of the portions of the first SaaS application; and
pushing the SaaS application lookup table to one or more additional peer computer systems, each acting as a proxy to the SaaS application server on the network once a threshold number of active peer computer systems using the first SaaS application have entered the network, wherein the one or more additional proxies feed the SaaS application lookup table to each new peer computer system entering the network.

4. The method of claim 3, further comprising:
the first computer system requesting access to the first SaaS application;
streaming at least a portion of the first SaaS application from the SaaS server to the first computer system when the threshold number of active peer computer systems on the network has not been reached; and
streaming all portions of the first SaaS application from at least one of the one or more peer computer systems on the network to the first computer system when the threshold number of active peer computer systems has been reached.

5. The method of claim 3, further comprising:
sending an applet to a non-peer computer system requesting access to the first SaaS application, wherein the applet grants the non-peer computer system access to the first SaaS application.

6. A system, comprising:
a network;
a first peer computer system coupled to the network;
one or more additional peer computer systems coupled to the network,
wherein the first peer computer system comprises a software as a service (SaaS) application lookup table to store a first categorized set of pointers, wherein each pointer includes one or more storage locations within at least one of the one or more peer computer systems where at least a portion of a first SaaS application resides, the first peer computer system to
request access to one or more portions of the first SaaS application from at least one of the one or more peer computer systems storing at least one of the one or more portions of the first SaaS application; and
when access is granted, receive one or more streams of the one or more portions of the first SaaS application from the at least one of the one or more peer computer systems on the network.

7. The system of claim 6, further comprising:
a SaaS proxy, coupled to the network, to
store the SaaS application lookup table populated with a first categorized set of blocks; and
feed the SaaS application lookup table to a plurality of new peer computer systems entering the network.

8. The system of claim 7, wherein the SaaS proxy is further operable to:
track the number of peer computer systems on the network;
push the SaaS application lookup table to one or more additional SaaS proxies on the network once the number of active peer computer systems on the network has reached a threshold number, the one or more additional SaaS proxies on the network to then feed the SaaS application lookup table to any further new peer computer system entering the network,
wherein the SaaS proxy discontinues to feed the SaaS application lookup table to client computer systems once the SaaS application lookup table has been pushed to the one or more additional SaaS proxies.

9. The system of claim 8, wherein the SaaS proxy is further operable to provide updates for the SaaS application lookup table to the one or more additional SaaS proxies.

10. The system of claim 8, wherein SaaS application lookup table further comprises a security key, the security key to qualify the first peer computer system to receive one or more streams of the one or more portions of the first SaaS application from at least one of the one or more other peer computer systems on the network,
wherein the SaaS proxy is further operable to check the integrity of the security key integrity.

11. The system of claim 8, wherein the SaaS proxy is further operable to
log one or more license requests to the first SaaS application on the network; and
deny access to the first SaaS application by any peer computer system on the network when all licenses for the first SaaS application are exhausted

12. The system of claim 8, wherein the SaaS proxy is further operable to convey the one or more license requests to a service provider.

13. The system of claim 8, wherein the SaaS proxy is further operable to push all of its services to one or more additional SaaS proxies.

14. The system of claim 8, wherein the SaaS proxy is further operable to provide a peer computer system, invited by an invitation initiating peer computer system, temporary access to the first SaaS application.

15. The system of claim 14, wherein the temporary access is limited to portions of time when the invitation initiating peer computer system is not utilizing the first SaaS application.
